(19) United States
(12) Patent Application Publication
(10) Pub. No.: US 2007/0097626 A1
(43) Pub. Date: May 3, 2007

(54) Structure for heat dissipation in a portable computer

(76) Inventors: Wei-Cheng Huang, Taipei (TW); Sung-Lin Hsu, Taipei (TW)

Correspondence Address: BACON & THOMAS, PLLC, 625 SLATERS LANE, FOURTH FLOOR, ALEXANDRIA, VA, 22314, US

(21) Appl. No.: 11/583,079

(22) Filed: Oct. 19, 2006

(30) Foreign Application Priority Data
Nov. 3, 2005 (TW) 094219018

(51) Int. Cl. G06F 1/20

(52) U.S. Cl. 361/687

(57) ABSTRACT

The structure for heat dissipation in a portable computer according the present invention is a structural design that provides an additional heat dissipation room in the main containing space inside the notebook computer, and provides heat dissipation module in the heat dissipation room, such that the efficiency of heat dissipation is raised. The heat dissipation module includes a heat conductor, a fan, and a heat dissipation plate. Besides, air inlet and air outlet are provided in the heat dissipation room to enable air convection during heat exchange, and accordingly ameliorate the drawback of insufficient heat dissipation in a conventional structure.

### BACKGROUND OF THE INVENTION

1) Field of the Invention

The present invention is a structure for heat dissipation in a portable computer. Specifically, the present invention utilizes additional heat dissipation space and heat dissipation module, which is composed of heat dissipation devices, to raise the capability of heat dissipation, to solve the problem of insufficient heat dissipation in contemporary notebook computers.

2) Description of the Prior Art

With the fast development of computer technology, the computing ability of CPU is raised, the problem of heat dissipation caused by chips needs more concern, the technology of heat dissipation accordingly becomes an important issue. For notebook computer, the installation of heat dissipation module is limited by its small space, the problem of insufficient heat dissipation is therefore more serious.

The heat dissipation system of a conventional notebook computer is shown in FIG. 1 and FIG. 2. In the containing space 8, a heat sink 2 is attached on the chip 3 of main board 4. The heat generated by chip 3 is conducted to the heat sink 2, then cooled and drained out through outlet 81 by fan 1.

This type of heat dissipation module was installed inside internal space 8 of computer. Since, in the containing space, there exist other devices and electric circuits on the main board 4, the space provided for heat exchange is limited, the area and effect for heat dissipation is thus constrained.

However, with the raising of computing speed, the heat generated by chip operation is significantly increased, the ability of a conventional heat dissipation module in the notebook computer gradually does not meet the requirement of heat dissipation.

Based on the problem of insufficient heat dissipation stated above, a structure for heat dissipation in a portable computer according to the present invention is thus introduced. In the present invention, an additional heat dissipation room is provided to increase the space of heat exchange and thus enhance the effect of heat dissipation. Besides, the present invention utilizes heat dissipation module provided in the heat dissipation room to significantly increase the capability of heat dissipation, and in consequence solves the problem of insufficient heat dissipation accompanied by modern notebook computers.

### SUMMARY OF THE INVENTION

The primary purpose of the structure for heat dissipation in a portable computer according the present invention is to provide sufficient space and area for heat dissipation for notebook computer, in order to solve the problem of insufficient heat dissipation that the existing notebook computers cope with.

The present invention provides a heat dissipation room inside the case of a usual notebook computer. The heat dissipation room is separated from the internal space of computer by a separator. A heat dissipation module is provided in the heat dissipation room. The heat dissipation module includes a heat conductor, a fan, a heat dissipation plate. The heat dissipation plate includes multiple fins.

One end of the heat conductor is connected to the heat sink, while the other end is connected to the heat dissipation plate, such that the heat generated by chip is promptly conducted to the heat dissipation plate and then the exchanged heat is blown out of the case by the fan.

With the installation of heat dissipation room and heat dissipation plate, the area of heat dissipation plate as well as the space of heat exchange is considerably increased, the whole capability of heat dissipation is raised, and the problem of insufficient heat dissipation that modem notebook computers is coping with is accordingly solved.

### BRIEF DESCRIPTION OF THE DRAWINGS

FIG. 1 is a schematic depiction showing the allocation of heat dissipation module in a conventional notebook computer.

FIG. 2 is a top view showing the allocation of heat dissipation module in a conventional notebook computer.

FIG. 3 shows the heat dissipation module and structure in accordance with the present invention.

FIG. 4 is a top view showing the heat dissipation module and structure in accordance with the present invention.

FIG. 5A is a schematic depiction of heat dissipation plate in accordance with an embodiment of the present invention.

FIG. 5B is a schematic depiction of heat dissipation plate in accordance with another embodiment of the present invention.

FIG. 6 shows the heat dissipation module and structure in accordance with another embodiment of the present invention.

FIG. 7A shows the allocation of heat dissipation plate and fan in accordance with an embodiment of the present invention.

FIG. 7B shows the allocation of heat dissipation plate and fan in accordance with another embodiment of the present invention.

FIG. 8 shows the heat dissipation module with thermoelectric cooling kit in accordance with an embodiment of the present invention.

FIG. 9 shows the heat dissipation module with heat insulator in accordance with an embodiment of the present invention.

FIG. 10 shows the heat dissipation module in accordance with another embodiment of the present invention.

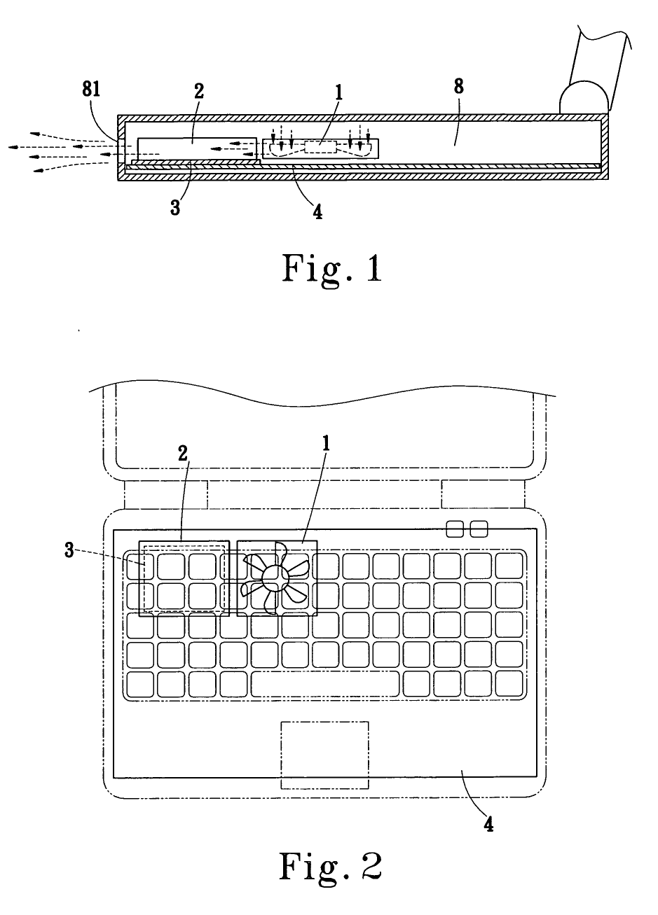

### DETAILED DESCRIPTION OF THE PREFERRED EMBODIMENTS

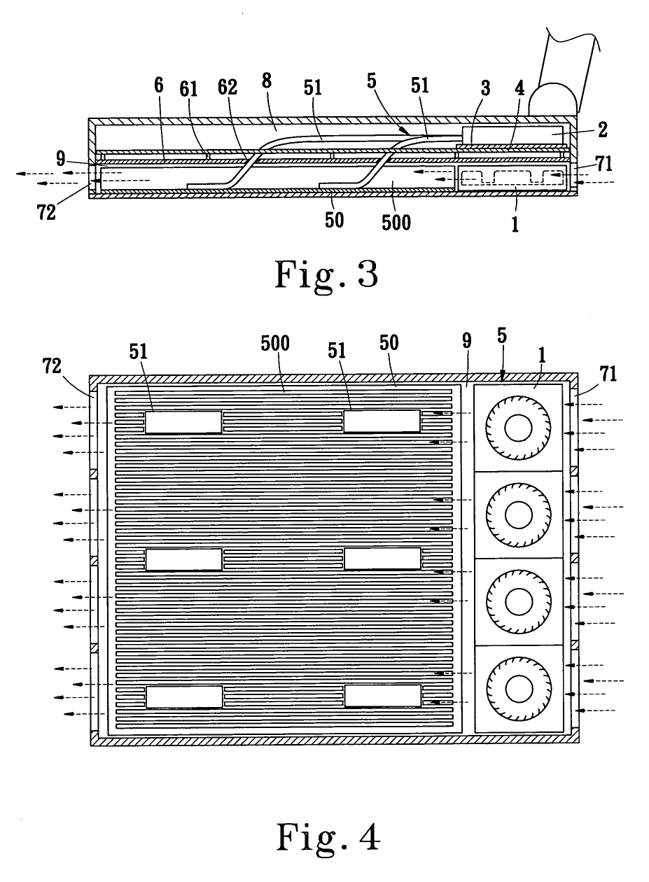

Referring to FIGS. 3 and 4 are the best embodiments of this invention, which show that structure for heat dissipation in a portable computer according to the present invention installs an additional heat dissipation room 9 in the containing space 8 of a notebook computer, for allocating conductor 51, heat dissipation plate 50 and fan 1 of heat dissipation module 5. The heat dissipation module 5 at least includes a heat conductor 51, a heat dissipation plate 50, a fan 1.

The heat dissipation room 9 is separated from containing space 8 by a heat insulator 6. On the heat insulator 6 multiple convex parts 61 and holes 62 are provides. The holes 62 are provided for penetrating heat conductor 51. The heat conductor 51 conducts heat between heat sink 2 and heat dissipation plate 50. Multiple convex parts 61 are provided for fixing main board 4 or other devices.

There exist(s) one or more than one heat conductor(s) 51 in the heat dissipation module 5. For each heat conductor 51, one end is attached on the heat sink 2 which installed on chip 3 of main board 4 (which is installed in the containing space 8), while the other end is connected to the heat dissipation plate 50. When computer works, the heat generated by chip 3 is conducted to heat sink 2, the heat conductor 51 then conducts heat to the heat dissipation plate 50 (which is installed in the heat dissipation room 9). Multiple fins 500 are set on the heat dissipation plate 50 for increasing the dissipation area as well as the effect of heat dissipation.

Then, the fan 1 draws cool air from inlet 71, the cool air is blown to heat dissipation plate 50 and fins 500, the hot air is drained out of the case through outlet 72. The whole effect of heat dissipation is thus significantly increased, the problem of insufficient heat dissipation that modem notebook computers is coping with is accordingly solved.

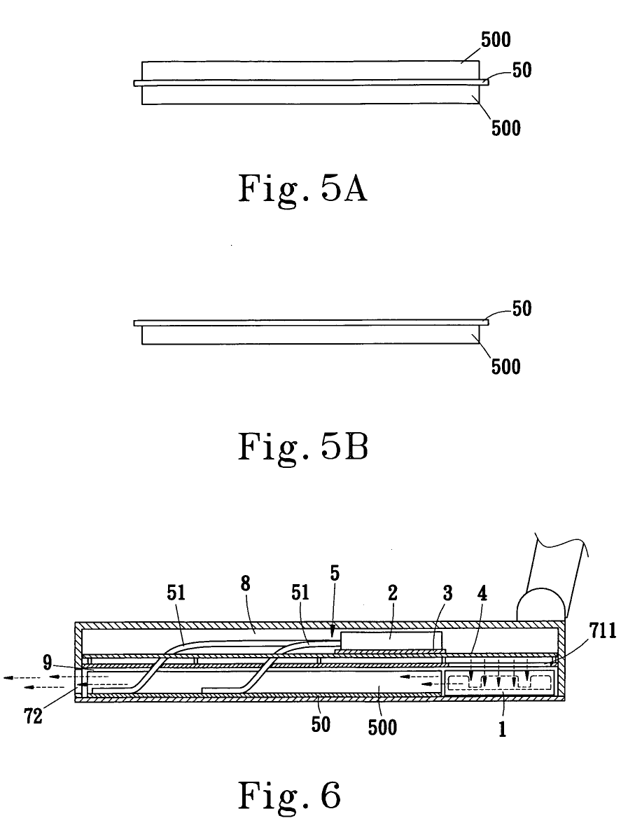

Further referring to FIG. 5A and FIG. 5B, where the heat dissipation plate 50 and fins 500 in accordance with an embodiment of the present invention is disclosed. As shown, fins 500 can be set on either dual sides or single side of the heat dissipation plate 50.

Furthermore, referring to FIG. 6, which shows the structure for heat dissipation in a portable computer according to another embodiment of the present invention. Remembering that, in FIG. 3, the fan 1 draws cool air from inlet 71, the cool air is blown to heat dissipation plate 50 and fins 500, the hot air is drained out of the case through outlet 72. As compared with FIG. 3, the present embodiment installs inlet 711 on the top of fan 1, such that the fan 1 draws external air from the upside inlet 711. After performing heat exchange with the heat dissipation plate 50 and fins 500, the heat air is drained out of the case through outlet 72.

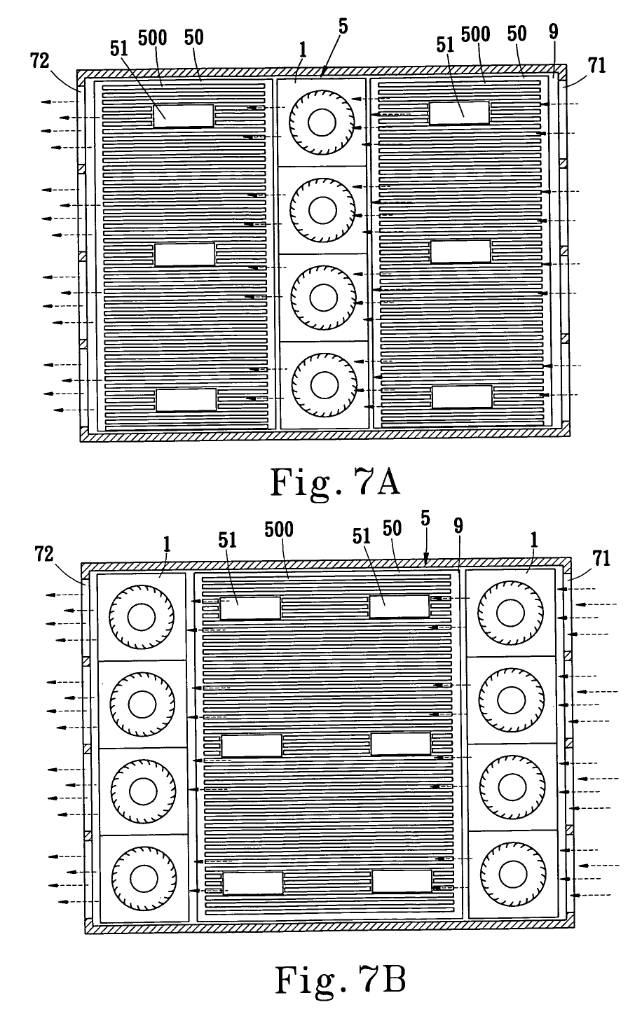

Additionally, referring to FIG. 7A and FIG. 7B, which show the allocation of heat dissipation plate and fan in accordance with an embodiment of the present invention. As shown in FIG. 7A, the fan 1 may be installed at the center of heat dissipation room 9, the cool air is blown from center to the heat dissipation plate 50 and fins 500 that installed at both sides. The exchanged heat is then drained out through the outlets 72 located at the corners.

Also, as shown in FIG. 7B, fan 1 installed near the inlet 71 at one side of heat dissipation room 9 draws external air, after exchanging heat with the heat dissipation plate 50 and fins 500, the hot air is drained out through fan 1 installed near the outlet 72 at another side of heat dissipation plate 50.

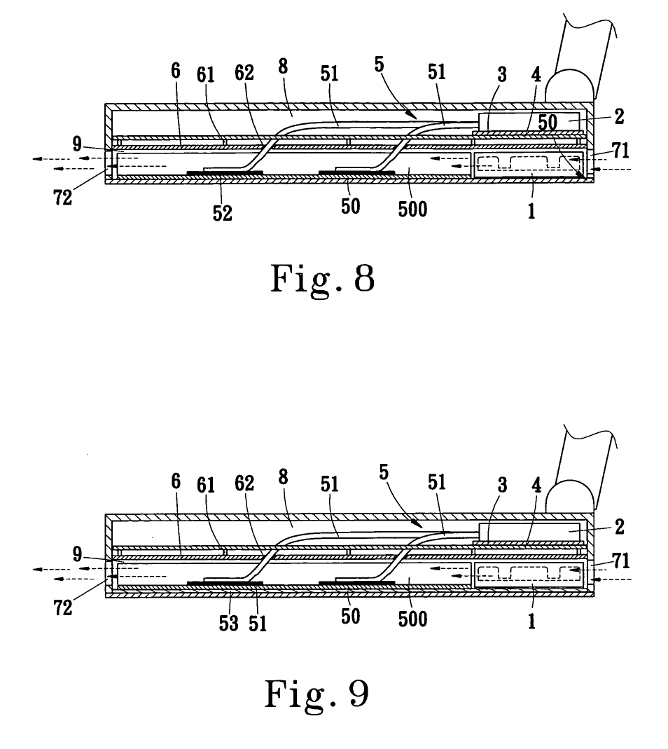

Moreover, referring to FIG. 8, which shows the heat dissipation module in accordance with another embodiment of the present invention. A thermoelectric cooling kit 52 is installed between heat conductor 51 and heat dissipation plate 50, to accelerate the effect of cooling and expand the contact area for heat dissipation.

Still, referring to FIG. 9, which shows the heat dissipation room in accordance with another embodiment of the present invention. In the heat dissipation room 9, an additional heat insulator 53 is installed at the bottom of heat dissipation plate 50. The said heat insulator 53 is made of material that doest not conduct heat, such that the heat of heat dissipation plate 50 in heat dissipation room 9 is not conducted to the bottom of computer case. Consequently, the user won't be burned by putting the portable computer on the laptop.

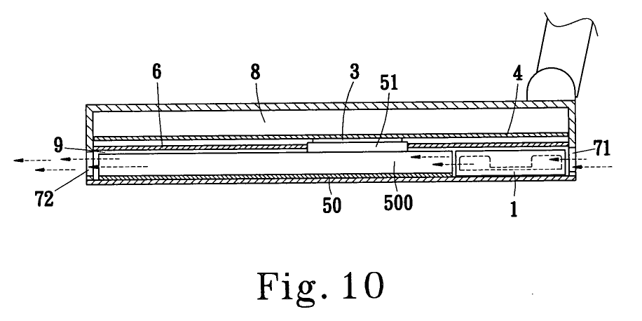

What's more, referring to FIG. 10, which reversely installs the chip 3 of main board 4 in the containing space 8. The other end of heat conductor 51 contacts the heat dissipation plate 50 such that, during operation, the heat generated by chip 3 is directly conducted to the heat conductor 51, and then conducted to the heat dissipation plate 50 in the heat dissipation room 9. With the help of fins 500, the area as well as the effect for heat dissipation is increased. In this embodiment, the heat conductor 51 may be embodied by a heat pipe or a thermoelectric cooling kit 52.

What is claimed is:

1. A structure for heat dissipation in a portable computer, more specifically, an additional heat dissipation room is installed in a notebook computer, the said heat dissipation room is separated from the containing space in the computer by a separator, such that a heat dissipation module is installed inside the heat dissipation room, and air inlets and air outlets are provided at both sides of the heat dissipation room; the said heat dissipation module is composed of a heat conductor, a fan, and a heat dissipation plate, wherein
one end of the heat conductor, which is provided for conducting heat, is attached on the chip of main board or heat sink of the chip, while the other end is attached on the heat dissipation plate in the dissipation room;
the fan, which is provided for forcing air convection and heat exchange, is installed in the heat dissipation room with locations of installation corresponding to the air inlets and air outlets;
The heat dissipation plate, which is made of metal material with good property of heat dissipation, is formed with multiple fins on the surface, and is connected by the heat conductor;
the said heat dissipation module is provided mainly for conducting heat generated by the chip in the containing space of computer through heat conductor to the heat dissipation plate in the heat dissipation room, and then accelerates the air convection by the fans through air inlets and air outlets.

2. A structure for heat dissipation in a portable computer in accordance with claim 1, wherein the heat conductor may be embodied by a heat pipe.

3. A structure for heat dissipation in a portable computer in accordance with claim 1, wherein the heat conductor may be embodied by a thermoelectric cooling kit.

4. A structure for heat dissipation in a portable computer in accordance with claim 1, wherein an additional thermoelectric cooling kit may be put between the heat conductor and the heat dissipation plate.

5. A structure for heat dissipation in a portable computer in accordance with claim 1, wherein an additional heat insulator may be installed under the bottom of heat dissipation room.

6. A structure for heat dissipation in a portable computer, more specifically, an additional heat dissipation room is installed in notebook computer, the said heat dissipation room is separated from the containing space in the computer by a separator, such that heat dissipation module is installed inside the heat dissipation room, and air inlets and air outlets are provided at both sides of the heat dissipation room; the said heat dissipation module at least includes a heat conductor, a fan, and a heat dissipation plate, wherein
the chip on the main board of the containing space is reversely installed, such that the heat conductor of the heat dissipation module directly contacts the chip, and the other end of heat conductor contacts heat dissipation plate, the heat generated by chip is directly conducted to heat conductor and then conducted to the heat dissipation plate in the heat dissipation room, in order to increase area and effect for heat dissipation.
